(19) United States
(12) Patent Application Publication
(10) Pub. No.: US 2014/0085773 A1
(43) Pub. Date: Mar. 27, 2014

(54) HYBRID ELECTROCHEMICAL ENERGY STORAGE DEVICE

(71) Applicants: Sergiy Chernukhin, Boyarka (UA); Dmytro Tretyakov, Kharkiv (UA); Yuriy Maletin, KIEV (UA)

(72) Inventors: Sergiy Chernukhin, Boyarka (UA); Dmytro Tretyakov, Kharkiv (UA); Yuriy Maletin, KIEV (UA)

(73) Assignee: Yunasko Limited, London (GB)

(21) Appl. No.: 14/037,339

(22) Filed: Sep. 25, 2013

Related U.S. Application Data
(60) Provisional application No. 61/705,306, filed on Sep. 25, 2012.

(51) Int. Cl. H01G 11/06

(52) U.S. Cl. CPC H01G 11/06
USPC 361/502

(57) ABSTRACT

Disclosed is a hybrid electrochemical energy storage device which can store much larger energy density than known electrochemical double layer capacitors (EDLC's) and, simultaneously, can provide high power density and efficiency comparable with those of known EDLC's.

### CROSS REFERENCE TO RELATED APPLICATION

This application claims priority to a U.S. provisional application Ser. No. 61/705,306 entitled “Hybrid Electrochemical Energy Storage Device”, filed on Sep. 25, 2012, which is incorporated in its entirety herein by reference.

### FIELD

The present teachings are related to energy storage devices, in particular to electrochemical double layer capacitors (EDLC's) which are often called as supercapacitors or ultracapacitors.

### BACKGROUND

EDLC devices draw much attention due to their high power capability and efficiency (a typical EDLC can deliver more than 2 kW/kg at 95% efficiency), and also due to their long life cycle (the number of charge-discharge cycles can reach millions). On the other hand, an essential EDLC drawback is their low energy density that does not typically exceed 20-30 kJ/kg with so-called symmetrical EDLC's comprising two nanoporous carbon electrodes of opposite polarity. This value is significantly lower than the energy density of conventional lead-acid (100-150 kJ/kg) or Li-ion (400-600 kJ/kg) batteries. Therefore, the present teachings are related to hybrid electrochemical devices which combine the chemistries of EDLC's and Li-ion batteries and can store much more energy than EDLC's while still being capable of delivering high power at high efficiency.

Known methods for fabricating hybrid energy storage devices are mostly based on so-called asymmetrical systems which include one electrode (positive or negative) comprising a nanoporous carbon and storing energy due to formation of a double electric layer on its porous surface, and another electrode of the opposite sign comprising a battery-type material capable of storing energy due to electrochemical or faradaic processes, e.g., intercalation of lithium ions into a crystal lattice of electrode material, as, for example, is disclosed in U.S. Pat. No. 8,107,223, U.S. Pat. No. 7,974,073, and U.S. Pat. No. 7,211,350 (all of which are incorporated by reference herein in their entirety).

However, the hybrid technologies known up to date enable to increase the energy density up to 40-70 kJ/kg only, and, unfortunately, at the expense of significant reduction of power capability (1 kW/kg or less at 95% efficiency). This drawback is due to a series connection of EDLC-type and battery-type electrodes in known hybrid technologies, wherein the former electrode limits the energy stored, and the latter limits the power output.

In order to increase the energy density while keeping the high level of power density a different approach was proposed, as described in the following references: S. I. Chemukhin, D. O. Tretyakov, et al., Electrochemical Hybrid Devices to Combine Functions of Li-ion Battery and Supercapacitor. 10th International Conference on Energy Transformation in Lithium Electrochemical Systems, Saratov, Russia, Jun. 23-27, 2008, p. 214-215; R. Kötz et al., Roads to High Energy Electrochemical Capacitors. Presented at 62nd Annual Meeting of the International Society of Electrochemistry, Niigata, Japan, Sep. 11-16, 2011; R Kötz et al., J. Power Sources, 2011, vol. 196, #23, pp. 10305-10313; and R Kötz et al., Electrochimica Acta, 2012, vol. 27, pp. 1-17 (all of which are incorporated by reference herein in their entirety). The approach was termed a “parallel hybrid”. According to this approach both electrodes are fabricated as mixtures of nanoporous carbon and Li-intercalating materials. However, though theoretically this technology can provide both large energy and high power density, real prototypes demonstrate rather modest performance.

### SUMMARY

In certain aspects the present teachings provide for a hybrid electrochemical energy storage device. The device of the present teachings includes a positive electrode and a negative electrode. The positive and negative electrodes are interleaved with a porous separator and are impregnated with a liquid electrolyte. The active masses of the positive and negative electrodes contain a first active material and a second active material. The first active material contains an intercalation material capable of storing energy due to reversible intercalation of lithium ions. The second active material contains a nanoporous carbon material capable of storing energy due to formation of electric double layer at a carbon-electrolyte interface. The positive electrode contains a first and a second intercalation materials. The first intercalation material is capable of enabling a higher positive charge-discharge potential range and a higher power output than the second intercalation material. The second intercalation material is capable of enabling a larger capacity and a lower charge-discharge potential range than the first intercalation material. A mass ratio between the nanoporous carbon material and the first or the second intercalation materials may lie in a range from about 0.1 to about 10. The first or second intercalation materials may be selected from the group including LiCoO₂, LiₓMn₂O₄, LiNiₓCo_{y}O₂, LiNiₓMn_{y}O₂, LiNiₓCo_{y}Al_{z}O₂, LiMnₓNi_{y}Co_{y}O₂, LiFePO₄, and LiFeMnPO₄. A mass ratio of the first and the second intercalation materials may lie in a range from about 0.1 to about 10. The negative electrode may contain a powdered mixture of lithium titanate and a nanoporous carbon having their mass ratio in a range from about 0.1 to about 10. The hybrid electrochemical energy storage device may further include an electrolyte. The electrolyte may comprise a Lithium and tetraalkylammonium salt, and a solvent. The salt may have an anion selected from the group including tetrafluoroborate (BF₄⁻), hexafluorophosphate (PF₆⁻), hexafluoroarsenate (AsF₆⁻), perchlorate (ClO₄⁻), trifluoromethane sulphonate (SO₃CF₃⁻), bis(trifluoromethane sulphone) imide (N(SO₂CF₃)₂⁻), bis(perfluoroethane sulphone) imide (N(SO₂C₂F₅)₂⁻), bis(fluorosulphone) imide (N(SO₂F)₂⁻), and bis-oxalatoborate (B(C₂O₄)₂⁻). The solvent may be selected from the group including acetonitrile, propionitrile, propylene carbonate, ethylene carbonate, diethyl carbonate, and methylethyl carbonate.

### BRIEF DESCRIPTION OF THE DRAWINGS

The following drawings and descriptions are provided to aid in the understanding of the invention:

FIG. 1 shows cyclic voltammetry curves for two intercalation materials of the positive electrode: LiₓMn₂O₄ with more positive charge-discharge potential range, and LiFePO₄ with less positive charge-discharge potential range, the dashed vertical line indicates an approximate low boundary for positive electrode operation potential;

FIG. 2 shows cyclic voltammetry curves for two intercalation materials of the positive electrode: LiₓMn₂O₄ with more positive charge-discharge potential range, and LiNiₓCo_{y}Al_{z}O₂ lying partly in less positive charge-discharge potential range, the dashed vertical line indicates an approximate low boundary for positive electrode operation potential;

FIG. 3 shows charge-discharge curves of the hybrid electrochemical energy storage device;

FIG. 4 shows a potential curve for the first charge-discharge cycle of the positive electrode containing the nanoporous carbon powder and a mixture of two intercalation materials: LiMn₂O₄ (material 1) and LiFePO₄ (material 2); and

FIG. 5 shows a plot of available energy density vs. power density (Ragone plot) for a hybrid electrochemical energy storage device according to the present teachings and for a similar device produced by JSR Micro N.V. (the measurements were carried out in the Institute of Transportation Studies, Davis, Calif.).

### DETAILED DESCRIPTION

The present teachings provide for a hybrid electrochemical energy storage device which can store much larger energy density than known electrochemical double layer capacitors (EDLC's) and, simultaneously, can provide high power density and efficiency comparable with those of known EDLC's.

In certain aspects a hybrid electrochemical energy storage device of the present teachings is implemented by assembling an energy storage device that includes at least one positive and one negative electrodes with a porous separator interposed in between. The electrodes and the separator are impregnated with an electrolyte. The positive and negative electrodes comprise two types of active materials, namely, so-called intercalation materials capable of storing energy resulting from reversible intercalation of lithium ions and nanoporous carbon materials capable of storing energy resulting from formation of a double electric layer at the carbon-electrolyte interface. In an example embodiment, as an intercalation material for the negative electrode, lithium titanate is selected to best match the working potential ranges of the intercalation material and the nanoporous carbon. Since lithium titanate, when being charged, bonds a portion of lithium ions irreversibly and this process reduces the available energy of the system, one of the key propositions of the present teachings is using at least two lithium-containing intercalation materials in the positive electrode, the materials demonstrating different discharge characteristics. At least one of these materials—material 1 below—is selected such that it has a high positive charge-discharge potential and is capable of providing a high specific power or, in other words, is capable of supporting fast charge-discharge processes. Another intercalation material in the positive electrode—material 2 below—is selected such that it is capable to be charged-discharged in a lower potential range than material 1, possesses larger specific capacity (or larger amount of lithium ions per unit mass) than material 1, and thus is capable of compensating the partial loss of lithium ions due to their irreversible bonding at the negative electrode.

In certain aspects a hybrid electrochemical energy storage device of the present teachings is implemented by way of selecting material 1 and material 2 such that the charge-discharge potential range of material 1 is more positive than the charge-discharge potential range of material 2, at least in part. This can provide a compensation process, which involves material 2 as described above, to occur at low voltage, namely below the potential range of material 1 operation. In other words, this enables material 1 to effectively operate at a higher voltage thus providing higher power and energy densities.

In certain aspects the present teachings provide for the use of a mixture of intercalation materials with different discharge characteristics in the positive electrode, which can increase the medium discharge potential of this electrode. For example, if a certain material (LiₓMn₂O₄ in this example) demonstrates a high power output and has a smooth discharge curve, while another material (LiNiₓCo_{y}Al_{z}O₂ in this example) is close to the former by its power capability and has an even larger capacity but demonstrates a rather steep decrease in voltage during the discharge, the use of their mixture results in a larger capacity, as compared with the former material, and a higher medium voltage, as compared with the latter one.

In certain aspects a hybrid energy storage device of the present teachings includes the negative electrode (anode) prepared as a mixture of lithium titanate (e.g., Li₄Ti₅O₁₂) powder and a nanoporous carbon powder, with their mass ratio selected in a range from about 0.1 to about 10. The positive electrode (cathode) is a mixture of a nanoporous carbon powder and at least two of compounds selected, for example, from the following set: LiCoO₂, LiMn₂O₄, LiNiₓCo_{y}O₂, LiNiₓMn_{y}O₂, LiNiₓCo_{y}Al_{z}O₂, LiMnₓNi_{y}Co_{z}O₂, LiFePO₄, LiFeMnPO₄. Mass ratio between the nanoporous carbon powder and lithium intercalation materials lies in a range from about 0.1 to about 10. Beside the powders of active electrochemical materials, both electrodes comprise as complementary materials at least one conductive additive (e.g., carbon black and/or graphite from about 1 to about 25% by weight) and a binder, e.g., polytetrafluoroethylene (PTFE), polyvinylidene difluoride (PVDF), carboxymethyl cellulose (CMC) or polyvinyl alcohol (PVA). The mixture of active and complementary materials thus obtained and called below as electrode material is applied on a conductive current collector utilizing any known methods such as, e.g., rolling the mixture of the electrode material followed by laminating it onto the current collector surface or coating the current collector with a slurry of the electrode material followed by drying it. The hybrid energy storage device includes at least two such current collectors covered with the electrode material on at least one side, the electrode materials of the opposite polarity are facing each other and are interleaved with a porous insulating film (separator). The current collectors are connected to the terminals of the same polarity utilizing ultrasonic or laser welding. The entire system is soaked in organic electrolyte, placed into a special container and hermetically sealed. Thus, according to the present teachings an example embodiment of the hybrid energy storage device has the following distinguishing features:
Active material of the positive electrode (cathode) contains a powdered mixture of a nanoporous carbon and at least two of the compounds selected from the following set: LiCoO₂, LiMn₂O₄, LiNiₓCo_{y}O₂, LiNiₓMn_{y}O₂, LiNiₓCo_{y}Al_{z}O₂, LiMnₓNi_{y}Co_{z}O₂, LiFePO₄, LiFeMnPO₄. Combinations of these materials are selected such that at least a first intercalation material is capable enabling a more positive charge-discharge potential range and a higher power output, while a second intercalation material is capable of enabling a larger capacity but a lower charge-discharge potential range than the first intercalation material.
The ratio of the nanoporous carbon mass and the total mass of at least two intercalation materials in the positive electrode lies in a range from about 0.1 to about 10. In turn, the mass ratio of intercalation materials in their mixture lies in a range from about 0.1 to about 10.
Active material of the negative electrode (anode) contains a powdered mixture of lithium titanate and a nanoporous carbon with their mass ratio selected in a range from about 0.1 to about 10.
As an electrolyte, at least one salt of lithium and one of tetraalkylammonium, i.e. a compound of a general formula:

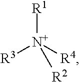

where R¹-R⁴ groups may be the same or different alkyl or aryl groups, with an anion selected from the group including tetrafluoroborate (BF₄⁻), hexafluorophosphate (PF₆⁻), hexafluoroarsenate (AsF₆⁻), perchlorate (ClO₄⁻), trifluoromethane sulphonate (SO₃CF₃⁻), bis(trifluoromethane sulphone) imide (N(SO₂CF₃)₂⁻), bis(perfluoroethane sulphone) imide (N(SO₂C₂F₅)₂⁻), bis(fluorosulphone) imide (N(SO₂F)₂⁻), and bis-oxalatoborate (B(C₂O₄)₂⁻) dissolved in a solvent selected from the group including acetonitrile, propionitrile, propylene carbonate, ethylene carbonate, diethyl carbonate, methylethyl carbonate and their mixtures can be used.

The present teachings are described in more detail below through Figures and Examples. It should be understood, however, that the present teachings are not limited to these Figures and Examples but can as well be embodied in other forms and devices without departing from the scope and spirit of the teachings.

The following Examples illustrate the forgoing aspects and other aspects of the present teachings. These non-limiting Examples are put forth so as to provide those of ordinary skill in the art with illustrative embodiments as to how the compounds, compositions, articles, devices, and/or methods claimed herein are made and evaluated. The Examples are intended to be purely exemplary of the inventions disclosed herein and are not intended to limit the scope of what the inventors regard as their invention. Efforts have been made to ensure accuracy with respect to numbers (e.g., amounts, temperature, etc.) but some errors and deviations should be accounted for.

### EXAMPLES

### Example 1

A hybrid energy storage device comprising a block of 21 double-sided positive electrodes and 20 double-sided plus two one-sided negative electrodes, electrode materials being laminated onto the aluminum foil of 20 micron thick (current collector) surface, a porous polyethylene separator of 12 micron thick being interposed between positive and negative electrode materials, current collectors being welded to the corresponding current leads (aluminum foil of 0.5 mm thick) with the use of ultrasonic welding, was assembled. Total visible area of both positive and negative electrode was 1500 cm². The whole block was then soaked with organic electrolyte and hermetically sealed in a laminated aluminum foil (pouch-type case). Thickness of negative electrode material, which contained 30% wt. of nanoporous carbon powder, 50% wt. of Li₄Ti₅O₁₂, 10% wt. of carbon black, and 10% wt. of PTFE binder, was 50 micron; thickness of positive electrode material, which contained 25% wt. of nanoporous carbon powder, 50% wt. of LiMn₂O₄, 10% wt. of LiFePO₄, 5% wt. of carbon black, and 10% wt. of PTFE binder, was 100 micron. A mixture of 2M LiN(SO₂CF₃)₂ and 0.3M CH₃(C₂H₅)₃NBF₄ in acetonitrile was used as an electrolyte.

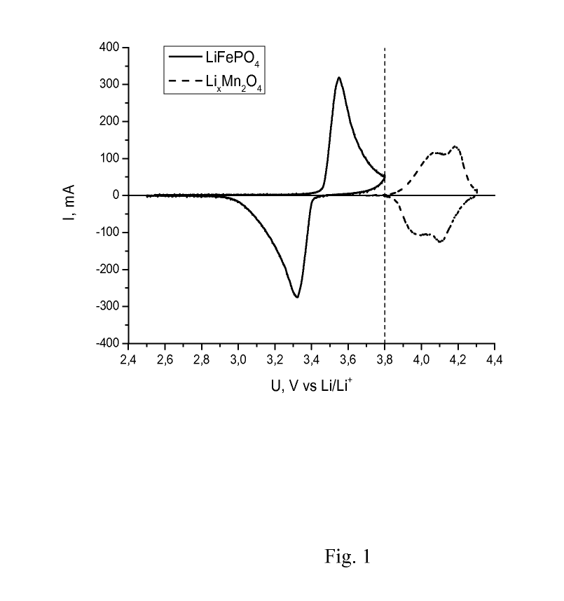

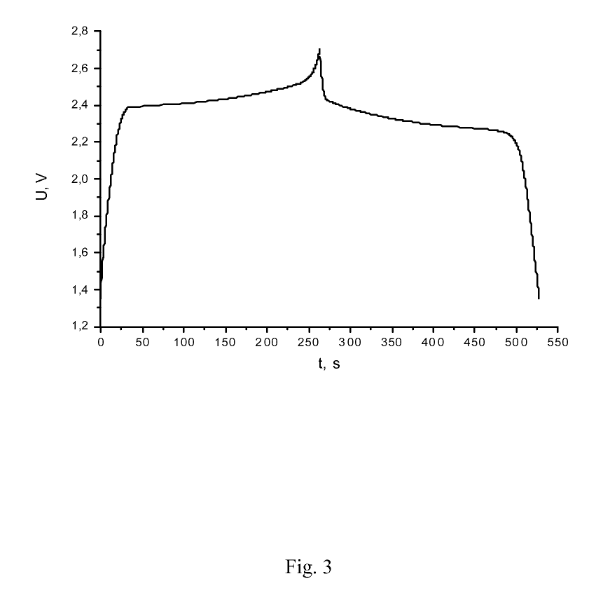

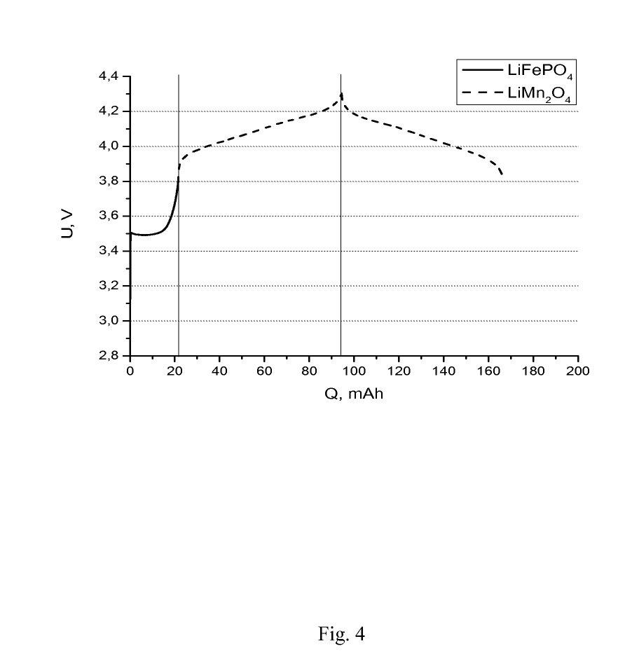

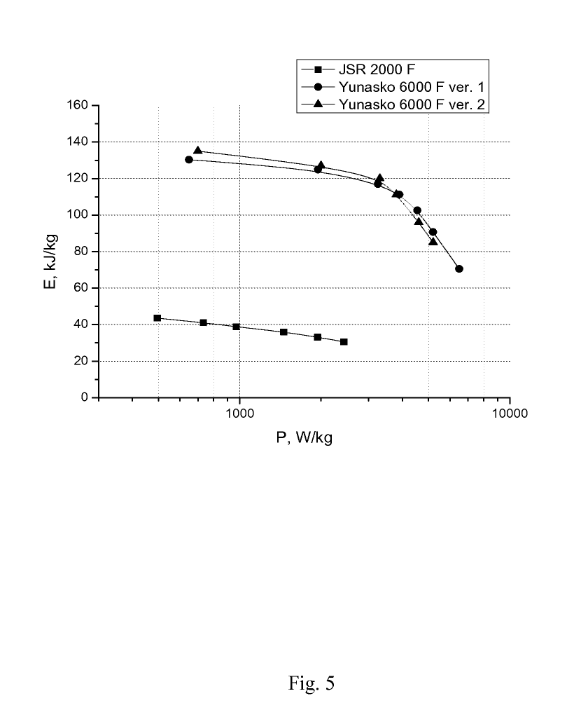

Performance of a hybrid energy storage device thus obtained is shown in FIG. 3 and FIG. 5 (Yunasko 6000 F, ver. 1). Potential ranges of charge-discharge processes for positive electrode materials are shown in FIG. 1 and FIG. 4.

### Example 2

A hybrid energy storage device comprising a block of 21 double-sided positive electrodes and 20 double-sided plus two one-sided negative electrodes, electrode materials being laminated onto the aluminum foil of 20 micron thick (current collector) surface, a porous polyethylene separator of 12 micron thick being interposed between positive and negative electrode materials, current collectors being welded to the corresponding current leads (aluminum foil of 0.5 mm thick) with the use of ultrasonic welding, was assembled. Total visible area of both positive and negative electrode was 1500 cm². The whole block was then soaked with organic electrolyte and hermetically sealed in a laminated aluminum foil (pouch-type case). Thickness of negative electrode material, which contained 25% wt. of nanoporous carbon powder, 60% wt. of Li₄Ti₅O₁₂, 5% wt. of carbon black, and 10% wt. of PTFE binder, was 50 micron; thickness of positive electrode material, which contained 25% wt. of nanoporous carbon powder, 30% LiMn₂O₄, 25% LiNiₓCo_{y}Al_{z}O₂, 5% wt. of carbon black, 5% wt. of graphite and 10% wt. of PTFE binder, was 90 micron. A mixture of 1.8M LiN(SO₂CF₃)₂, 0.2M LiBF₄ and 0.3M CH₃(C₂H₅)₃NBF₄ in acetonitrile was used as an electrolyte.

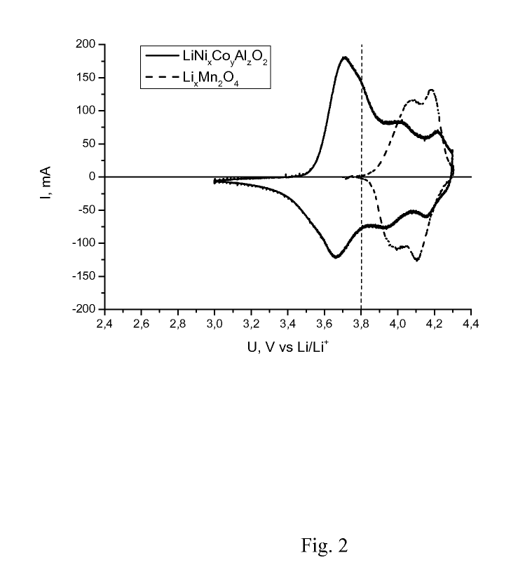

Performance of a hybrid energy storage device thus obtained is shown in FIG. 5 (Yunasko 6000 F, ver. 2). Potential ranges of charge-discharge processes for positive electrode materials are shown in FIG. 2.

In FIG. 5 the ratio between energy and power densities (Ragone plot) of hybrid devices according to the present teachings is also compared with similar performance of a hybrid energy storage device known by name of Lithium Ion Capacitor and produced by JSR Micro N.V. (Technologielaan 8, (B-3001, Leuven, Belgium). The corresponding test data were obtained at the Institute of Transportation Studies, Davis, Calif., USA. As can be seen from this comparison, hybrid devices assembled in accordance with the present teachings demonstrate significantly larger energy density and higher power capability than one of the best hybrid devices available in the market.

All publications and patents mentioned herein are hereby incorporated by reference in their entirety as if each individual publication or patent was specifically and individually indicated to be incorporated by reference.

While specific embodiments of the subject matter have been discussed, the above specification is illustrative and not restrictive. Many variations will become apparent to those skilled in the art upon review of this specification and the claims below. The full scope of the invention should be determined by reference to the claims, along with their full scope of equivalents, and the specification, along with such variations.

What is claimed is:

1. A hybrid electrochemical energy storage device, said device comprising:
a positive electrode and a negative electrode;
wherein said positive and negative electrodes are interleaved with a porous separator and impregnated with a liquid electrolyte;
wherein active masses of said positive and negative electrodes comprise a first active material and a second active material,
said first active material comprising an intercalation material capable of storing energy due to reversible intercalation of lithium ions, and
said second active material comprising a nanoporous carbon material capable of storing energy due to formation of electric double layer at a carbon-electrolyte interface; and
wherein said positive electrode comprises a first and a second intercalation material,
said first intercalation material possessing a higher positive charge-discharge potential range and a higher power output than said second intercalation material,
while said second intercalation material possessing a larger capacity and a lower charge-discharge potential range than said first intercalation material.

2. The hybrid electrochemical energy storage device of claim 1, wherein a mass ratio between said nanoporous carbon material and said first or said second intercalation materials lies in a range from about 0.1 to about 10.

3. The hybrid electrochemical energy storage device of claims 1, wherein said first or second intercalation materials are selected from the group comprising:
LiCoO₂,
LiₓMn₂O₄,
LiNiₓCo_{y}O₂,
LiNiₓMn_{y}O₂,
LiNiₓCo_{y}Al_{z}O₂,
LiMnₓNi_{y}Co_{z}O₂,
LiFePO₄, and
LiFeMnPO₄.

4. The hybrid electrochemical energy storage device of claims 2, wherein said first or second intercalation materials are selected from the group comprising:
LiCoO₂,
LiₓMn₂O₄,
LiNiₓCo_{y}O₂,
LiNiₓMn_{y}O₂,
LiNiₓCo_{y}Al_{z}O₂,
LiMnₓNi_{y}Co_{z}O₂,
LiFePO₄, and
LiFeMnPO₄.

5. The hybrid electrochemical energy storage device of claims 1, wherein a mass ratio of said first and said second intercalation materials lies in a range from about 0.1 to about 10.

6. The hybrid electrochemical energy storage device of claims 2, wherein a mass ratio of said first and said second intercalation materials lies in a range from about 0.1 to about 10.

7. The hybrid electrochemical energy storage device of claims 1, wherein said negative electrode comprises a powdered mixture of lithium titanate and nanoporous carbon having their mass ratio in a range from about 0.1 to about 10.

8. The hybrid electrochemical energy storage device of claims 2, wherein said negative electrode comprises a powdered mixture of lithium titanate and nanoporous carbon having their mass ratio in a range from about 0.1 to about 10.

9. The hybrid electrochemical energy storage device of claims 1, further comprising and electrolyte, said electrolyte comprising:
a salt of lithium or tetraalkylammonium,
having an anion selected from the group comprising:
tetrafluoroborate (BF₄⁻),
hexafluorophosphate (PF₆⁻),
hexafluoroarsenate (AsF₆⁻),
perchlorate (ClO₄⁻),
trifluoromethane sulphonate (SO₃CF₃⁻),
bis(trifluoromethane sulphone) imide (N(SO₂CF₃)₂⁻),
bis(perfluoroethane sulphone) imide (N(SO₂C₂F₅)₂⁻),
bis(fluorosulphone) imide (N(SO₂F)₂⁻), and
bis-oxalatoborate (B(C₂O₄)₂⁻); and
a solvent selected from the group comprising:
acetonitrile,
propionitrile,
propylene carbonate,
ethylene carbonate,
diethyl carbonate, and
methylethyl carbonate.

10. The hybrid electrochemical energy storage device of claims 2, further comprising and electrolyte, said electrolyte comprising:
a salt of lithium or tetraalkylammonium,
having an anion selected from the group comprising:
tetrafluoroborate (BF₄⁻),
hexafluorophosphate (PF₆⁻),
hexafluoroarsenate (AsF₆⁻),
perchlorate (ClO₄⁻),
trifluoromethane sulphonate (SO₃CF₃⁻),
bis(trifluoromethane sulphone) imide (N(SO₂CF₃)₂⁻),
bis(perfluoroethane sulphone) imide (N(SO₂C₂F₅)₂⁻),
bis(fluorosulphone) imide (N(SO₂F)₂⁻), and
bis-oxalatoborate (B(C₂O₄)₂⁻); and
a solvent selected from the group comprising:
acetonitrile,
propionitrile,
propylene carbonate,
ethylene carbonate,
diethyl carbonate, and
methylethyl carbonate.
